(19) United States
(12) Patent Application Publication
(10) Pub. No.: US 2018/0222296 A1
(43) Pub. Date: Aug. 9, 2018

(54) ROOF APPARATUS FOR VEHICLE

(71) Applicant: AISIN SEIKI KABUSHISIKI KAISHA, Kariya-shi (JP)

(72) Inventors: Takanori HATTORI, Wuxi (CN); Kinju UCHIDA, Kariya-shi (JP)

(73) Assignee: AISIN SEIKI KABUSHISIKI KAISHA, Kariya-shi (JP)

(21) Appl. No.: 15/704,533

(22) Filed: Sep. 14, 2017

(30) Foreign Application Priority Data
Feb. 8, 2017 (JP) 2017-021131

(51) Int. Cl. B60J 7/02; B60J 7/043

(52) U.S. Cl. CPC B60J 7/022; B60J 10/90; B60J 7/043

(57) ABSTRACT

A roof apparatus for a vehicle includes: a movable panel configured to be movably attached to a roof of the vehicle; a guide rail that guides the movable panel; and a garnish connected to the movable panel and the guide rail, The garnish includes an attachment portion connected to an attachment panel of the movable panel, and an engagement portion slidably connected to the guide rail, the attachment portion includes an upper extension piece extending outwards in a vehicle width direction, and a lower extension piece extending outwards in the vehicle width direction below the upper extension piece, and the upper extension piece includes a first protrusion protruding downwards so as to be engaged with an engagement portion of the attachment panel, and a second protrusion protruding upwards, and is inserted into a gap between the movable panel and the attachment panel.

### CROSS REFERENCE TO RELATED APPLICATIONS

This application is based on and claims priority under 35 U.S.C. § 119 to Japanese Patent Application 2017-021131, filed on Feb. 8, 2017, the entire contents of which are incorporated herein by reference.

### TECHNICAL FIELD

This disclosure relates to a roof apparatus for a vehicle, which moves a movable panel.

### BACKGROUND DISCUSSION

As a vehicle roof apparatus, there has been known a technology described in JP 2011-093471A (Reference 1). The vehicle roof apparatus described in Reference 1 includes a movable panel, a pair of guide rails that guide the movable panel, and a garnish that connects the movable panel to the guide rails in the vertical direction of a vehicle. The upper end portion of the garnish is slidably attached to the movable panel. The lower end portion of the garnish is slidably attached to the guide rails.

Meanwhile, in the vehicle roof apparatus described in Reference 1, the upper end portion of the garnish includes an engaging claw portion. The engaging claw portion is engaged with a through hole of an attachment panel provided in the movable panel. In the case of this configuration, due to the deformation of the garnish such as twisting, the engaging claw portion may be disengaged from the through hole of the attachment panel, and the upper end portion of the garnish may escape from the movable panel.

### SUMMARY

A roof apparatus for a vehicle according to an aspect of this disclosure includes a movable panel configured to be movably attached to a roof of a vehicle, a guide rail that guides the movable panel, and a garnish connected to the movable panel and the guide rail. The garnish includes an attachment portion connected to an attachment panel of the movable panel at an upper side in a vehicle height direction, and an engagement portion slidably connected to the guide rail at a lower side in the vehicle height direction. The attachment portion includes an upper extension piece extending outwards in a vehicle width direction, and a lower extension piece extending outwards in the vehicle width direction below the upper extension piece in the vehicle height direction and cooperating with the upper extension piece so that the attachment panel of the movable panel is interposed between the upper extension piece and the lower extension piece. The upper extension piece includes a first protrusion protruding downwards in the vehicle height direction so as to be engaged with an engagement portion of the attachment panel of the movable panel, and a second protrusion protruding upwards in the vehicle height direction, and is inserted into a gap between the movable panel and the attachment panel so as to be engaged with the attachment panel.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematic view of a vehicle roof;

FIG. 2 is a sectional view of a vehicle roof apparatus according to an exemplary embodiment, which is taken along line 2-2 of FIG. 1;

FIG. 3 is a sectional view of an attachment portion in the vehicle roof apparatus according to the exemplary embodiment;

FIG. 4 is a sectional view of an engagement portion in the vehicle roof apparatus according to the exemplary embodiment;

FIG. 5 is a sectional view of the engagement portion in the vehicle roof apparatus according to the exemplary embodiment, when the engagement portion is engaged with a guide rail;

FIG. 6 is a sectional view of an attachment portion in a vehicle roof apparatus s a reference;

FIG. 7 is a sectional view of the attachment portion in the vehicle roof apparatus as a reference when the attachment portion is detached from an attachment panel;

FIG. 8 is a sectional view of an engagement portion in the vehicle roof apparatus as a reference;

FIG. 9 is a sectional view of the engagement portion in the vehicle roof apparatus as a reference when the engagement portion is engaged with a guide rail;

FIG. 10 is a sectional view of the engagement portion in the vehicle roof apparatus as a reference when the engagement portion is detached from the guide rail;

FIG. 11 is a sectional view of an attachment portion in a modification of the vehicle roof apparatus according to the exemplary embodiment; and

FIG. 12 is a sectional view of an engagement portion in a modification of the vehicle roof apparatus according to the exemplary embodiment.

### DETAILED DESCRIPTION

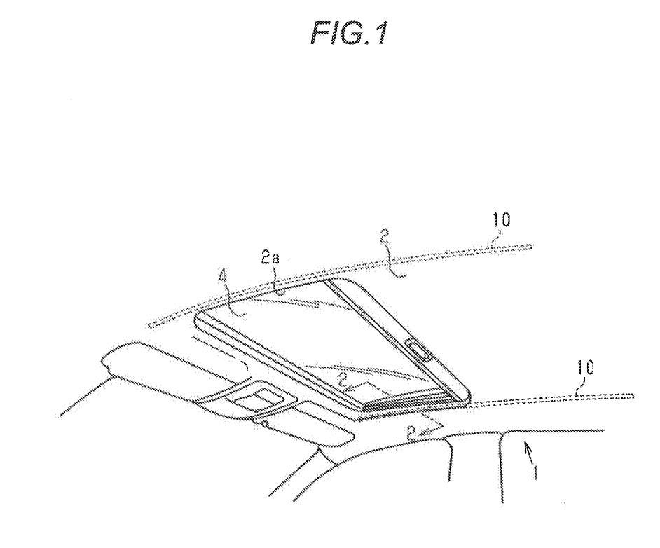

A vehicle roof apparatus will be described with reference to FIGS. 1 to 10.

In the following description, a “vehicle height direction” in a vehicle refers to a direction along a vertical direction when the vehicle is placed on a level flat ground. In the vehicle roof apparatus, a “vehicle height direction DZ” refers to a direction along the upward-downward direction of the vehicle with respect to a reference posture when a posture in which the vehicle roof apparatus is mounted in the vehicle is assumed as the reference posture. In the description of an exemplary embodiment, directions simply referred to as “upward” and “downward” directions indicate an upward direction and a downward direction in the vehicle height direction DZ in the reference posture of the vehicle roof apparatus. A “vehicle length direction” in a vehicle roof apparatus 6 refers to a direction along the forward-rearward direction of the vehicle when the vehicle roof apparatus 6 is placed in the reference posture. The vehicle length direction is perpendicular to the vehicle height direction DZ and a vehicle width direction DX. In the vehicle roof apparatus 6, the “vehicle width direction DX” indicates a direction along the leftward-rightward direction of the vehicle when the vehicle roof apparatus 6 is placed in the reference posture. In the vehicle width direction DX, a direction toward a passenger compartment is referred to as an “inward” direction and a direction toward the outside of the vehicle is referred to as an “outward” direction.

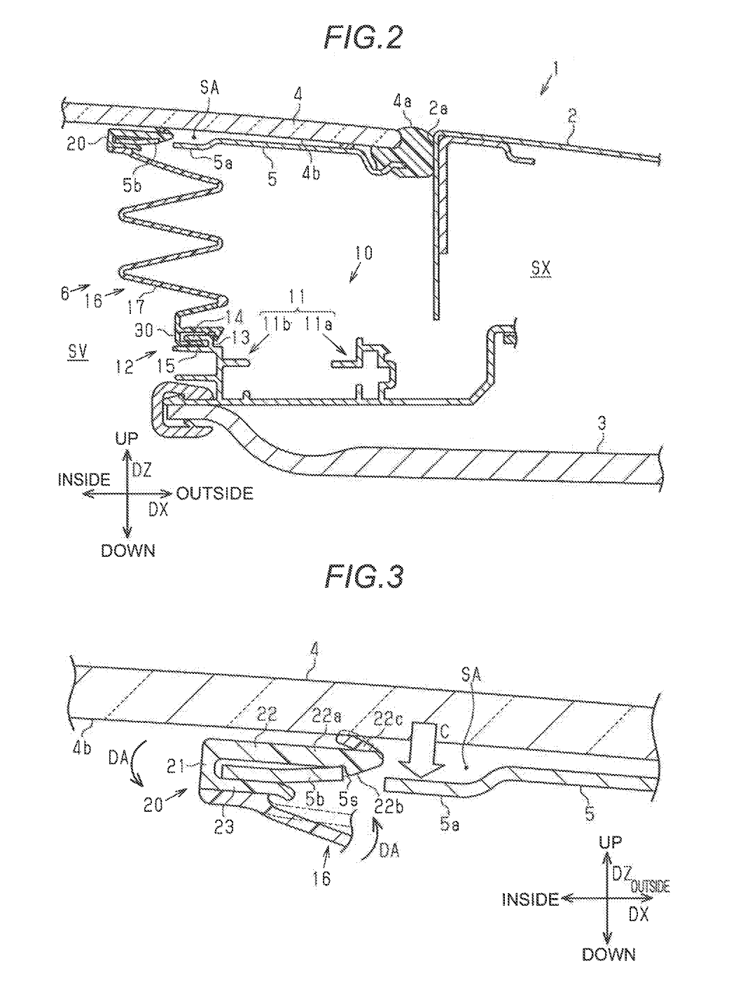

As illustrated in FIG. 1, the vehicle roof apparatus 6 is mounted in a vehicle. The vehicle roof apparatus 6 operates a movable panel 4 that closes an opening 2a opened in the roof 2 of a vehicle body 1. The vehicle roof apparatus 6 moves a sliding member (not illustrated) in the vehicle length direction, thereby moving the movable panel 4. A seal member 4a (also referred to as a “weather strip”) is attached to the peripheral edge of the movable panel 4 so as to prevent the invasion of water (see FIG. 2).

The vehicle roof apparatus 6 includes a pair of guide rails 10, the movable panel 4, and a pair of garnishes 16.

The guide rail 10 is fixed to a fixed panel 3 (see FIG. 2) below each of the opposite edges of the opening 2a in the vehicle width direction DX. The guide rail 10 is made of, for example, an extruded material of an aluminum-alloy, and extends in the vehicle length direction while having a constant section in the longitudinal direction.

As illustrated in FIG. 2, the guide rail 10 includes a first guide portion 11 that is opened upward, and a second guide portion 12 disposed inside the first guide portion 11 in the vehicle width direction DX.

The first guide portion 11 slidably guides a sliding member (not illustrated) in the vehicle length direction. The first guide portion 11 includes a first restriction wall 11a on the outside thereof, and a second restriction wall 11b inside the first restriction wall 11a. A sliding member is disposed between the first restriction wall 11a and the second restriction wall 11b. The movement of the sliding member is restricted by the first restriction wall 11a and the second restriction wall 11b in the vehicle width direction DX. The first restriction wall 11a and the second restriction wall 11b are bent, when viewed in a section.

The second guide portion 12 is provided on the second restriction wall 11b of the pair of walls constituting the first guide portion 11. The second guide portion 12 includes a first engagement wall 14, and a second engagement wall 15 aligned to be spaced downward apart from the first engagement wall 14 in the vehicle height direction DZ. The first engagement wall 14 and the second engagement wall 15 extend in parallel to each other in the vehicle length direction. The first engagement wall 14 and the second engagement wall 15 are supported by a support wall 13 located above the second restriction wall 11b, and extend Inwards from the support wall 13 in the vehicle width direction DX.

The movable panel 4 is connected to a sliding member via a link mechanism (not illustrated). The movable panel 4 moves when the sliding member moves along the first guide portion 11 based on the operation of the link mechanism. For example, the movable panel 4 moves in a tilt down state by the operation of the link mechanism. The tilt down state refers to a state in which the rear portion of the movable panel 4 is lowered compared to the front portion thereof.

An attachment panel 5 is fixed to the bottom surface 4b of the movable panel 4. An attachment portion 20 (see below) at the upper end portion of the garnish 16 is attached to the attachment panel 5. The attachment panel 5 is attached to the edge portion of the movable panel 4 in the vehicle width direction DX. The attachment panel 5 is constituted with a metal plate. The end portion of the attachment panel 5 at the vehicle interior side is displaced downwards to form an attachment piece 5a. A gap SA is formed between the bottom surface 4b of the movable panel 4 and the attachment piece 5a. Then, in the attachment piece 5a, an engagement portion 5b with which the attachment portion 20 of the garnish 16 is engaged is provided. In the exemplary embodiment, the engagement portion 5b has an engagement surface 5s extending in the vertical direction. For example, the engagement portion 5b is a cantilevered portion bordered by a U-shaped through hole in the attachment piece 5a and is configured as an upwardly bent portion.

The garnish 16 shields a space SX (see FIG. 2) outside the garnish 16, that is, the space SX where the first guide portion 11, the sliding member, or the like is disposed, from the side of a space SV within a passenger compartment. The garnish 16 includes a garnish body portion 17, the attachment portion 20 provided at the upper end portion of the garnish body portion 17, and an engagement portion 30 provided at the lower end portion of the garnish body portion 17.

The garnish body portion 17 is made of, for example, an extruded material of a resin. The garnish body portion 17 has a bellows structure folded in the vertical direction, and expands and contracts vertically. The garnish body portion 17 expands and contracts following the tilt down operation of the movable panel 4.

The attachment portion 20 of the garnish 16 will be described with reference to FIG. 3.

The attachment portion 20 is attached to the attachment panel 5 by being engaged with the attachment piece 5a. The attachment portion 20 is formed of a resin. Specifically, the attachment portion 20 includes an attachment body portion 21, an upper extension piece 22 extending outwards in the vehicle width direction DX from the attachment body portion 21, and a lower extension piece 23 disposed below the upper extension piece 22 in the vehicle height direction DZ and extending outwards in the vehicle width direction DX. The upper extension piece 22 and the lower extension piece 23 cooperate with each other so that the attachment piece 5a is interposed between the upper extension piece 22 and the lower extension piece 23.

The upper extension piece 22 is inserted into the gap SA between the movable panel 4 and the attachment piece 5a. The upper extension piece 22 includes a body portion 22a and a first protrusion 22b protruding downwards from the body portion 22a. The first protrusion 22b is engaged with the engagement portion 5b of the attachment piece 5a. Through the engagement, the first protrusion 22b and the engagement surface 5s of the engagement portion 5b are disposed such that the first protrusion 22b and the engagement surface 5s abut on each other. Thus, the upper extension piece 22 is suppressed from coming off. The body portion 22a and the first protrusion 22b may be integrally molded.

The upper extension piece 22 further includes a second protrusion 22c protruding upwards from the body portion 22a. The second protrusion 22c is made of a resin having elasticity. For example, the second protrusion 22c is made of a rubber or elastomer. The second protrusion 22c is elastically deformed. The second protrusion 22c may preferably extend obliquely upwards in a direction opposite to the extending direction of the upper extension piece 22 (see FIG. 3). Such a structure makes it easy for the upper extension piece 22 to enter the gap SA between the movable panel 4 and the attachment piece 5a, and makes it difficult for the upper extension piece 22 to come out of the gap SA. In the state where the upper extension piece 22 is inserted into the gap SA between the movable panel 4 and the attachment piece 5a, the second protrusion 22c is in contact with the bottom surface 4b of the movable panel 4 and is bent downward. Accordingly, the upper extension piece 22 is pressed toward the attachment piece 5a side (see the arrow C). The two-dot chain line in FIG. 3 illustrates the posture of the second protrusion 22c when the second protrusion 22c is not in contact with the bottom surface 4b of the movable panel 4.

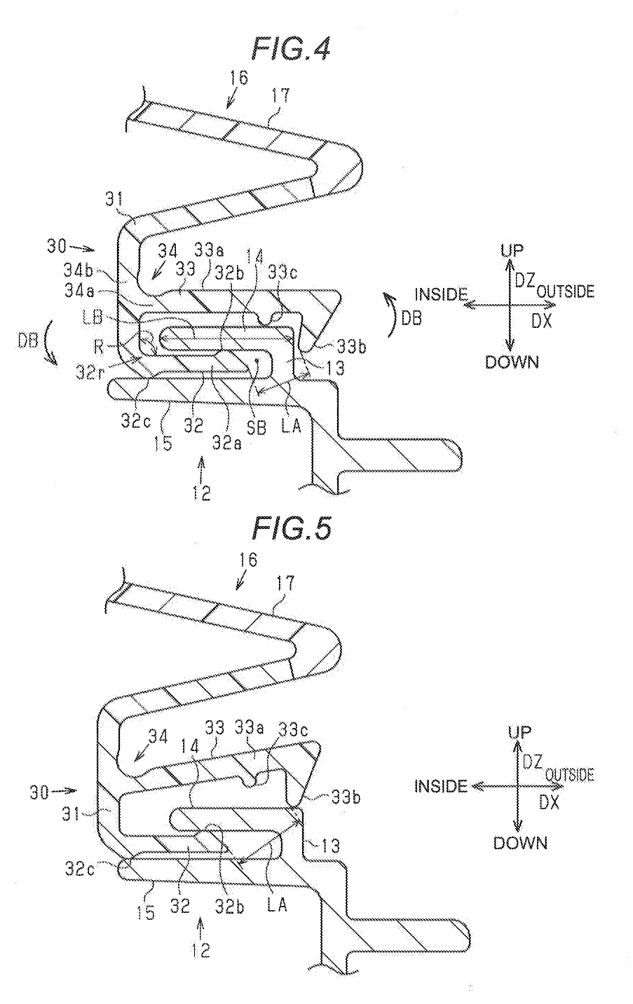

The engagement portion 30 of the garnish 16 will be described with reference to FIG. 4.

The engagement portion 30 is engaged with the second guide portion 12 of the guide rail 10. The engagement portion 30 slides in the vehicle length direction along the first engagement wall 14 of the second guide portion 12.

The engagement portion 30 includes a support portion 31 fixed to the lower end portion of the garnish 16, an upper engagement piece 33 extending outwards from the lower portion of the support portion 31 in the vehicle width direction DX, and a lower engagement piece 32 disposed below the upper engagement piece 33 in the vehicle height direction DZ and extending outwards in the vehicle width direction DX. The upper engagement piece 33 is disposed above the first engagement wall 14. The lower engagement piece 32 is disposed below the first engagement wall 14 and is inserted into a gap SB between the first engagement wall 14 and the second engagement wall 15. The upper engagement piece 33 and the lower engagement piece 32 cooperate with each other so that the first engagement wall 14 is interposed between the upper engagement piece 33 and the lower engagement piece 32.

The lower engagement piece 32 includes a body portion 32a. An upwardly protruding first contact portion 32b is provided in the body portion 32a of the lower engagement piece 32. The first contact portion 32b is in contact with the first engagement wall 14. A downwardly protruding second contact portion 32c is provided in the body portion 32a of the lower engagement piece 32. The second contact portion 32c is in contact with the second engagement wall 15.

Further, the engagement portion 30, as described below, includes a bent portion (see a “flexible portion 34” to be described below) to improve the attachment property.

A downwardly protruding claw portion 33b is provided at the distal end of a body portion 33a of the upper engagement piece 33. The claw portion 33b engages with the outer end of the first engagement wall 14. A downwardly protruding third contact portion 33c is provided in the body portion 33a of the upper engagement piece 33. The third contact portion 33c is in contact with the first engagement wall 14.

The first contact portion 32b, the second contact portion 32c, the third contact portion 33c, and the claw portion 33b are arranged at different positions in the vehicle width direction DX. Specifically, the second contact portion 32c, the first contact portion 32b, the third contact portion 33c, and the claw portion 33b are arranged outwardly in this order in the vehicle width direction DX.

The engagement portion 30 is restricted in movement in the vehicle height direction DZ and the vehicle width direction DX as described below. The lower engagement piece 32 is inserted into the gap SB between the first engagement wall 14 and the second engagement wall 15, the first contact portion 32b of the lower engagement piece 32 is in contact with the first engagement wall 14, and the second contact portion 32c of the lower engagement piece 32 is in contact with the second engagement wall 15. Accordingly, the engagement portion 30 is restricted in the movement in the vehicle height direction DZ. The support portion 31 of the engagement portion 30 is disposed at the inside of the inner end of the first engagement wall 14, and the claw portion 33b of the engagement portion 30 is disposed at the outside of the outer end of the first engagement wall 14. Accordingly, the engagement portion 30 is restricted in the movement in the vehicle width direction DX.

As a structure for maintaining the engagement between the engagement portion 30 and the first engagement wall 14, the engagement portion 30 includes the following structure. Specifically, an interval distance LA between the distal end portion of the lower engagement piece 32 and the claw portion 33b of the upper engagement piece 33 is shorter than a length LB of the first engagement wall 14 in the vehicle width direction DX.

The engagement portion 30 further has an attachment structure by which attachment in a direction intersecting the extension direction of the guide rail 10 becomes possible. The guide rail 10 has a constant section structure in the extension direction, and thus it is possible to attach the engagement portion 30 to the guide rail 10 by inserting the engagement portion 30 from the end in the extension direction. However, when the guide rail 10 is fixed to the vehicle, such a work takes time and effort. In this respect, when attachment in the direction intersecting the extension direction of the guide rail 10 is possible, attachment of the garnish 16 to the guide rail 10 fixed to the vehicle is simplified.

In such an attachment structure, the flexible portion 34 is provided in the upper engagement piece 33 of the engagement portion 30. The flexible portion 34 is an elastically bent portion. Due to the presence of the flexible portion 34, the upper engagement piece 33 is elastically bent with the flexible portion 34 as a boundary. The flexible portion 34 is provided at a connection portion between the support portion 31 and the upper engagement piece 33. The flexible portion 34 is configured to have a thinner thickness than a connection portion between the lower engagement piece 32 and the support portion 31. Specifically, the flexible portion 34 has a base portion 34a in the upper engagement piece 33 at the support portion 31 side and a portion 34b in the support portion 31 from which the upper engagement piece 33 protrudes. The thickness of the base portion 34a in the upper engagement piece 33 at the support portion 31 side is thinner than the thickness of a base portion in the lower engagement piece 32 at the support portion 31 side. The thickness of the portion 34b in the support portion 31 from which the upper engagement piece 33 protrudes is thinner than the thickness of the portion in the support portion 31 from which the lower engagement piece 32 protrudes.

Descriptions will be made on an operation of the engagement portion 30 when the engagement portion 30 of the garnish 16 is attached to the second guide portion 12 of the guide rail 10 with reference to FIG. 5.

As described above, the interval distance LA between the distal end of the lower engagement piece 32 and the claw portion 33b of the upper engagement piece 33 is shorter than the length LB of the first engagement wall 14 in the vehicle width direction DX. Thus, unless the interval distance LA increases, the first engagement wall 14 does not enter between the lower engagement piece 32 and the upper engagement piece 33. Therefore, the flexible portion 34 is provided in the upper engagement piece 33. When the first engagement wall 14 starts to enter the gap SB between the lower engagement piece 32 and the upper engagement piece 33, the upper engagement piece 33 is elastically bent at the flexible portion 34 and is raised by the first engagement wall 14. Then, since the interval distance LA increases, the first engagement wall 14 enters the space between the lower engagement piece 32 and the upper engagement piece 33. In this manner, the engagement portion 30 is engaged with the first engagement wall 14.

An action of h vehicle roof apparatus 6 according to the exemplary embodiment will be described.

First, an action of the attachment portion 20 will be described.

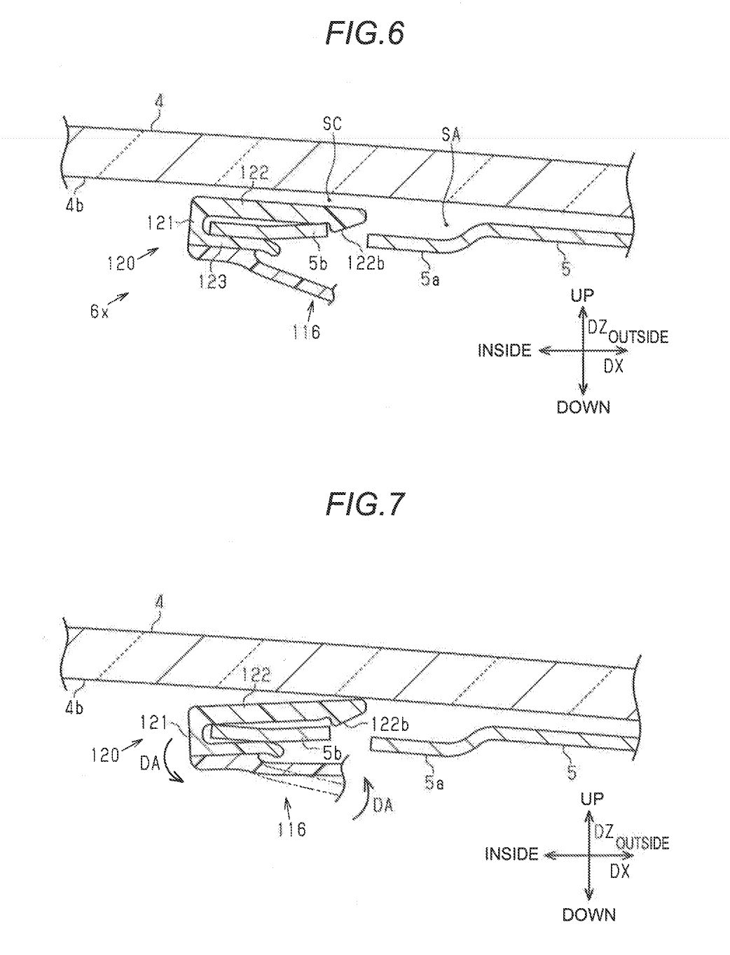

An action of the attachment portion 20 will be described with reference to FIGS. 6 and 7.

Descriptions will be made on detachment of an attachment portion 120 of a garnish 116 in a vehicle roof apparatus 6x as a reference which is compared to the vehicle roof apparatus 6 according to the exemplary embodiment.

FIG. 6 is a sectional view of the attachment portion 120 of the vehicle roof apparatus 6x as a reference. The attachment portion 120 includes an attachment body portion 121 an upper extension piece 122, and a lower extension piece 123. The upper extension piece 122 includes a first protrusion 122b to be engaged with the engagement portion 5b of the attachment piece 5a. These configurations have a structure conforming to the attachment portion 20 of the vehicle roof apparatus 6 according to the exemplary embodiment. The difference between the attachment portion 120 of the vehicle roof apparatus 6x as a reference and the attachment portion 20 of the vehicle roof apparatus 6 according to the exemplary embodiment is as follows. That is, in the attachment portion 120 of the vehicle roof apparatus 6x as a reference, the second protrusion 22c included in the attachment portion 20 of the vehicle roof apparatus 6 according to the exemplary embodiment is not provided. Thus, when the upper extension piece 122 is inserted into the gap SA between the movable panel 4 and the attachment piece 5a and the first protrusion 122b of the upper extension piece 122 is engaged with the engagement portion 5b of the attachment piece 5a, a gap SC remains above the first protrusion 122b of the upper extension piece 122. Then, the following phenomenon occurs. When the garnish 116 is largely deformed due to an unexpected situation such as a situation where things hit the garnish 116, a force beyond a specified range may be applied to the attachment portion 120 at the upper end portion of the garnish 116. For example, a rotational force in a rotational direction with a line along the vehicle length direction as a rotation center, that is, in a direction where the first protrusion 122b separates from the engagement portion 5b (hereinafter, a “detachment direction DA,” see FIG. 7), may act on the attachment portion 120. Then, the attachment portion 120 is detached from the engagement portion 5b.

FIG. 7 illustrates a sectional view of the attachment portion 120 when the rotational force in the detachment direction DA acts on the attachment portion 120. As illustrated in FIG. 7, when the attachment portion 120 rotates in the detachment direction DA, the first protrusion 122b separates from the engagement portion 5b, and the engagement between the first protrusion 122b and the engagement portion 5b is released. In such a state, when an inward force further acts on the garnish 116, the attachment portion 120 of the garnish 116 completely escapes from the attachment panel 5.

Next, an action of he vehicle roof apparatus 6 according to the exemplary embodiment will be described with reference to FIG. 3.

As described above, in the vehicle roof apparatus 6, the second protrusion 22c is provided in the upper extension piece 22 of the attachment portion 20. The second protrusion 22c upwardly protrudes toward the movable panel 4 side. Thus, compared to the vehicle roof apparatus 6x as a reference, the gap SC between the upper extension piece 22 and the movable panel 4 is narrowed at least in a part of a region, or disappears at least in a part of the region (see FIG. 3). Thus, even when a force (hereinafter, referred to as a “separating external force”) acts on the attachment portion 20 due to the deformation of the garnish 16 in a direction where the second protrusion 22c is separated from the engagement portion 5b, the releasing of the engagement between the first protrusion 22b and the engagement portion 5b is suppressed due to the following reasons. That is, in the case where the second protrusion 22c is in contact with the movable panel 4, when the separating external force acts on the attachment portion 20, a force that pushes back the upper extension piece 22 toward the engagement portion 5b side (a drag force in a direction indicated by the arrow C in FIG. 3) acts on the upper extension piece 22. Thus, the rotation of the attachment portion 20 is suppressed, and the releasing of the engagement between the first protrusion 22b and the engagement portion 5b is suppressed. In the case where the second protrusion 22c is not in contact with the movable panel 4, when the separating external force acts on the attachment portion 20, due to the presence of the second protrusion 22c, the upward movement of the upper extension piece 22 is suppressed, and thus the rotation of the attachment portion 20 is suppressed. Accordingly, the releasing of the engagement between the first protrusion 22b and the engagement portion 5b is suppressed. In this manner, the attachment portion 20 of the garnish 16 is suppressed from completely escaping from the attachment panel 5.

An action of the engagement portion 30 will be described with reference to FIG. 4 and FIGS. 8 to 10.

First, descriptions will be made on detachment of an engagement portion 130 of the garnish 116 in the vehicle roof apparatus 6x as a reference which is compared to the vehicle roof apparatus 6 according to the exemplary embodiment.

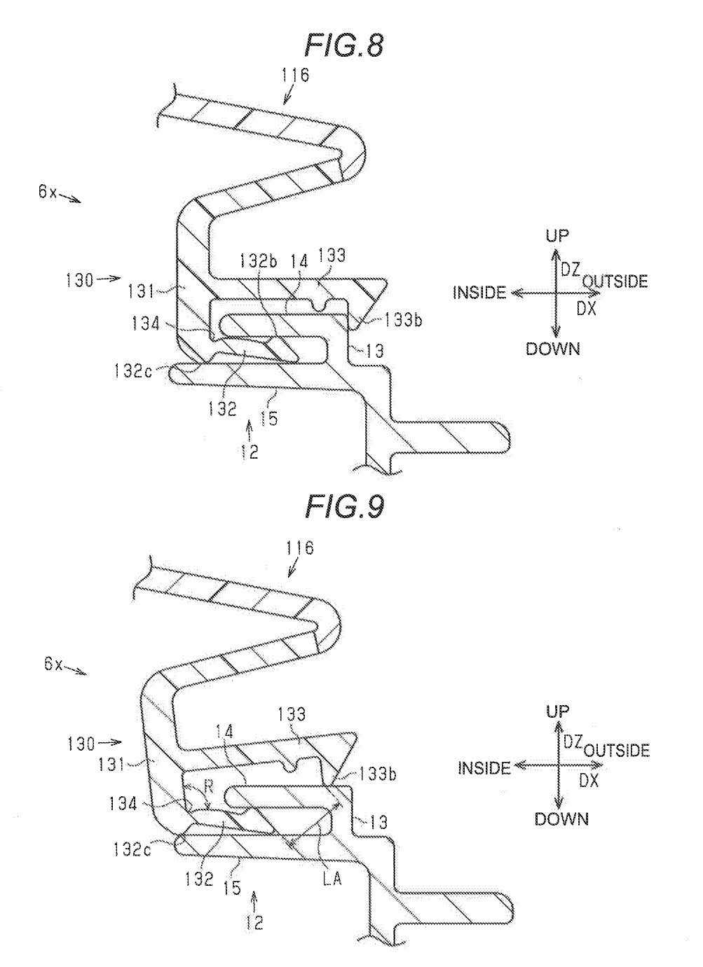

FIG. 8 is a sectional view of the engagement portion 130 of the vehicle roof apparatus 6x as a reference. The engagement portion 130 includes a support portion 131, a lower engagement piece 132, and an upper engagement piece 133. The upper engagement piece 133 includes a downwardly protruding claw portion 133b at the distal end thereof. The lower engagement piece 132 includes an upwardly protruding first contact portion 132b that is in contact with the first engagement wall 14. The lower engagement piece 132 includes a downwardly protruding second contact portion 132c that is in contact with the second engagement wall 15. These configurations have a structure conforming to the engagement portion 30 of the vehicle roof apparatus 6 according to the exemplary embodiment. The difference between the engagement portion 130 of the vehicle roof apparatus 6x as a reference and the engagement portion 30 of the vehicle roof apparatus 6 according to the exemplary embodiment is as follows. That is, in the engagement portion 30 of the vehicle roof apparatus 6 according to the exemplary embodiment, the flexible portion 34 is provided at the upper engagement piece 33, while in the reference example, a flexible portion 134 is provided at the lower engagement piece 132.

The flexible portion 134 has a structure by which the engagement portion 130 may be attached in a direction intersecting the extension direction of the guide rail 10 as in the exemplary embodiment.

As illustrated in FIG. 9, when the engagement portion 130 is attached to the first engagement wall 14 of the guide rail 10 in a direction intersecting the extension direction of the guide rail 10, the lower engagement piece 132 is elastically bent at the flexible portion 134, and an angle R between the support portion 131 and the lower engagement piece 132 increases. Then, since an interval distance LA between the distal end of the lower engagement piece 132 and the claw portion 133b of the upper engagement piece 133 increases, the first engagement wall 14 enters the space between the lower engagement piece 132 and the upper engagement piece 133. In this manner, the engagement portion 130 is engaged with the first engagement wall 14.

Meanwhile, when the garnish 116 is largely deformed due to an unexpected situation, a force may be applied to the engagement portion 130 at the lower end portion of the garnish 116. For example, a rotational force in a rotational direction with a line along the vehicle length direction as a rotation center, that is, in a direction where the claw portion 133b separates from the end of the first engagement wall 14 (hereinafter, a “detachment direction DB”), may act on the engagement portion 130.

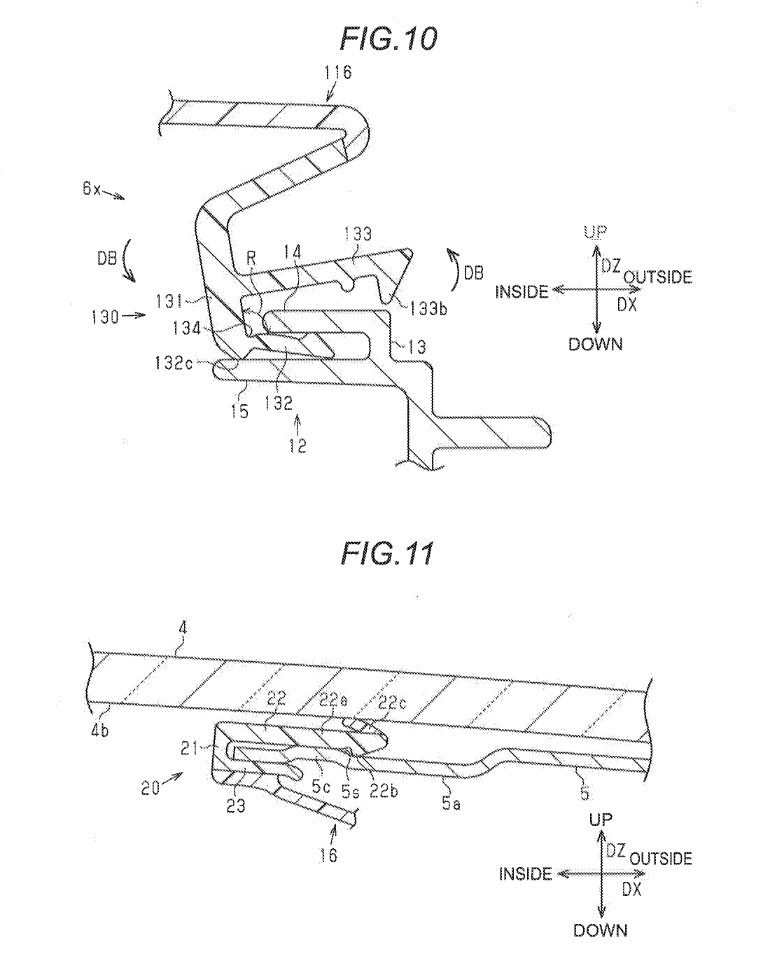

FIG. 10 illustrates a sectional view of the engagement portion 130 when the rotational force in the detachment direction DB acts on the engagement portion 130. As illustrated in FIG. 10, when the rotational force in the detachment direction DB acts on the engagement portion 130, the support portion 131 is inclined inwardly with the second contact portion 132c as a fulcrum, thereby increasing the angle R between the lower engagement piece 132 and the support portion 131. Then, the claw portion 133b of the upper engagement piece 133 separates from the first engagement wall 14 and the engagement between the claw portion 133b and the end of the first engagement wall 14 is released. In such a state, when an inward force further acts on the garnish 116, the engagement portion 130 of the garnish 116 completely escapes from the second guide portion 12.

Next, the vehicle roof apparatus according to the exemplary embodiment will be described with reference to FIG. 4.

In the vehicle roof apparatus 6, as described above, the flexible portion 34 is provided at the upper engagement piece 33, and the lower engagement piece 32 is hardly deformed as compared to the lower engagement piece 132 in the vehicle roof apparatus 6x as a reference. When the garnish 16 is largely deformed due to an unexpected situation, a force beyond a specified range may be applied to the engagement portion 30 at the lower end portion of the garnish 16. When the force is a rotational force in the detachment direction DB, the force acts on the engagement portion 30 such that the support portion 31 of the engagement portion 30 is inclined inwardly. This force acts such that the angle R between the support portion 31 and the lower engagement piece 32 is enlarged. Meanwhile, in the vehicle roof apparatus 6 according to the exemplary embodiment, the flexible portion 34 is not provided at the connection portion between the support portion 31 and the lower engagement piece 32. Thus, even when such a force acts, the enlargement of the angle R between the support portion 31 and the lower engagement piece 32 is suppressed. Thus, the claw portion 33b of the upper engagement piece 33 is suppressed from being raised upwards, and the releasing of engagement between the claw portion 33b and the end of the first engagement wall 14 is suppressed. Thus, the engagement portion 30 of the garnish 16 is suppressed from escaping from the second guide portion 12.

The vehicle roof apparatus 6 has the following effects.

(1) The attachment portion 20 of the garnish 16 includes the upper extension piece 22 and the lower extension piece 23 which cooperates with the upper extension piece 22 so that the attachment panel 5 of the movable panel 4 is interposed between the upper extension piece 22 and the lower extension piece 23. The upper extension piece 22 includes the first protrusion 22b engaged with the engagement portion 5b of the attachment panel 5 of the movable panel 4, and the upwardly protruding second protrusion 22c, and is inserted into the gap SA between the movable panel 4 and the attachment panel 5 so as to be engaged with the attachment panel 5.

According to this configuration, the second protrusion 22c provided in the upper extension piece 22 of the garnish 16 suppresses the upward movement of the upper extension piece 22 of the garnish 16. Accordingly, the upward movement of the first protrusion 22b engaged with the engagement portion 5b is suppressed, and the engagement between the first protrusion 22b and the engagement portion 5b of the attachment panel 5 is hardly released.

(2) The second protrusion 22c of the upper extension piece 22 of the attachment portion 20 is made of a resin having elasticity. According to this configuration, the upper extension piece 22 may be easily inserted into the gap SA between the movable panel 4 and the attachment panel 5.

(3) The second protrusion 22c of the upper extension piece 22 extends obliquely upwards in a direction opposite to the extension direction of the upper extension piece 22. According to this configuration, the upper extension piece 22 may be easily inserted into the gap SA between the movable panel 4 and the attachment panel 5.

(4) The engagement portion 30 includes the upper engagement piece 33, and the lower engagement piece 32 which cooperates with the upper engagement piece 33 so that the first engagement wall 14 is interposed between the upper engagement piece 33 and the lower engagement piece 32. The upper engagement piece 33 includes the claw portion 33b and the flexible portion 34 by which the upper engagement piece 33 is elastically bent.

In the case where the flexible portion 134 is provided in the lower engagement piece 132 as in the reference example illustrated in FIG. 10, when a force is applied to the lower engagement piece 132, the lower engagement piece 132 is easily bent, the gap between the lower engagement piece 132 and the upper engagement piece 133 is widened, and the claw portion 133b of the upper engagement piece 133 separates from the first engagement wall 14. Thus, the engagement between the upper engagement piece 133 and the first engagement wall 14 may be released. In this respect, in the above configuration, since the flexible portion 34 is present at the upper engagement piece 33 of the engagement portion 30, even when a force is applied to the lower engagement piece 32, the gap between the lower engagement piece 32 and the upper engagement piece 33 is hardly widened. Thus, the separation of the claw portion 33b of the upper engagement piece 33 from the first engagement wall 14, and the releasing of engagement between the upper engagement piece 33 and the first engagement wall 14 are suppressed.

(5) In the engagement portion 30, the flexible portion 34 is configured as a constriction at the connection portion between the support portion 31 and the upper engagement piece 33. Then, the flexible portion 34 is thinner than the thickness of the connection portion between the support portion 31 and the lower engagement piece 32.

According to this configuration, since the flexible portion 34 is configured as a thin portion of the upper engagement piece 33, the flexible portion 34 may have a simple configuration and may be easily formed as compared to the case where the flexible portion 34 is constituted by a member separate from the support portion 31 (e.g., an elastic resin). The flexible portion 34 may also be configured as a constriction of only the base portion 34a in the upper engagement piece 33 at the support portion 31 side.

### Other Exemplary Embodiment

The exemplary embodiment as described above may be modified as follows.
In the exemplary embodiment, the engagement portion 5b with which the first protrusion 22b of the attachment portion 20 of the garnish 16 is engaged may be configured as follows.

As illustrated in FIG. 11, an engagement portion 5c is configured as a protrusion provided in the attachment piece 5a. The inclined surface of the protrusion constitutes the engagement surface 5s with which the first protrusion 22b of the attachment portion 20 is engaged. Such a protrusion is formed as a convex portion protruding upwardly from the attachment piece 5a, through press-processing.
In the above described exemplary embodiment, the engagement portion 30 to be engaged with the second guide portion 12 of the guide rail 10 may be configured as follows.

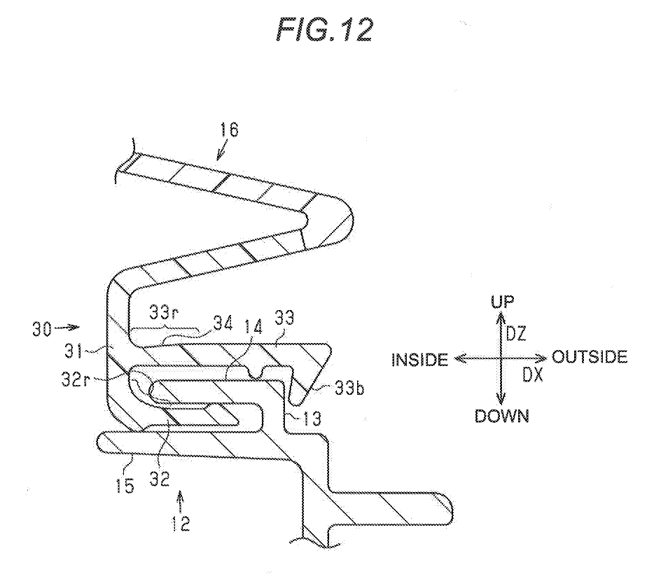

As illustrated in FIG. 12, the flexible portion 34 is not provided at the connection portion between the upper engagement piece 33 and the support portion 31 but provided at a base portion 33r at the upper engagement piece 33. Accordingly, the upper engagement piece 33 may be elastically bent, and the engagement portion 30 may be attached in a direction intersecting the extension direction of the guide rail 10. Further, the thickness of the base portion 32r of the lower engagement piece 32 is thicker than the thickness of the base portion 33r of the upper engagement piece 33. Accordingly, the enlargement of an angle between the support portion 31 and the lower engagement piece 32 is suppressed. In this manner, the releasing of the engagement between the claw portion 33b and the end of the first engagement wall 14 is suppressed.

(1) A roof apparatus for a vehicle according to an aspect of this disclosure includes a movable panel configured to be movably attached to a roof of a vehicle, a guide rail that guides the movable panel, and a garnish connected to the movable panel and the guide rail. The garnish includes an attachment portion connected to an attachment panel of the movable panel at an upper side in a vehicle height direction, and an engagement portion slidably connected to the guide rail at a lower side in the vehicle height direction. The attachment portion includes an upper extension piece extending outwards in a vehicle width direction, and a lower extension piece extending outwards in the vehicle width direction below the upper extension piece in the vehicle height direction and cooperating with the upper extension piece so that the attachment panel of the movable panel is interposed between the upper extension piece and the lower extension piece. The upper extension piece includes a first protrusion protruding downwards in the vehicle height direction so as to be engaged with an engagement portion of the attachment panel of the movable panel, and a second protrusion protruding upwards in the vehicle height direction, and is inserted into a gap between the movable panel and the attachment panel so as to be engaged with the attachment panel.

According to this configuration, the second protrusion provided in the upper extension piece of the garnish suppresses the upward movement of the upper extension piece of the garnish. Accordingly, the upward movement of the first protrusion engaged with the engagement portion is suppressed, and the engagement between the first protrusion and the engagement portion of the attachment panel is hardly released.

(2) In the roof apparatus, the second protrusion of the upper extension piece may be made of a resin having elasticity. According to this configuration, the upper extension piece may be easily inserted into the gap between the movable panel and the attachment panel.

(3) In the roof apparatus, the second protrusion of the upper extension piece may extend obliquely upwards in a direction opposite to an extension direction of the upper extension piece. According to this configuration, the upper extension piece may be easily inserted into the gap between the movable panel and the attachment panel.

(4) In the roof apparatus, the guide rail may include a first engagement wall, and a second engagement wall disposed below the first engagement wall in the vehicle height direction. The engagement portion may include an upper engagement piece disposed above the first engagement wall of the guide rail in the vehicle height direction, and a lower engagement piece disposed below the first engagement wall in the vehicle height direction and cooperating with the upper engagement piece so that the first engagement wall is interposed between the upper engagement piece and the lower engagement piece. The lower engagement piece may include a first contact portion upwardly protruding and being in contact with the first engagement wall, and a second contact portion downwardly protruding and being in contact with the second engagement wall. The upper engagement piece may have a claw portion downwardly protruding to be engaged with an end of the first engagement wall, and a flexible portion allowing the upper engagement piece to be elastically bent.

In the case where the flexible portion is provided in the lower engagement piece, when a force is applied to the lower engagement piece, the lower engagement piece is easily bent, the gap between the lower engagement piece and the upper engagement piece is widened, and the claw portion of the upper engagement piece separates from the first engagement wall. Thus, the engagement between the upper engagement piece and the first engagement wall may be released In this respect, in the above configuration, since the flexible portion is present at the upper engagement piece of the engagement portion, even when a force is applied to the lower engagement piece, it is difficult for the lower engagement piece to simply bend. Thus, even when a force is applied to the lower engagement piece, the gap between the lower engagement piece and the upper engagement piece is hardly widened. Thus, the separation of the claw portion of the upper engagement piece from the first engagement wall, and the releasing of engagement between the upper engagement piece and the first engagement wall are suppressed.

(5) In the roof apparatus, the engagement portion may include the upper engagement piece, the lower engagement piece, and a support portion that supports the upper engagement piece and the lower engagement piece. The flexible portion of the upper engagement piece may be configured as a constriction at a connection portion between the support portion and the upper engagement piece or a base portion at the support portion side, and may be thinner than a thickness at a connection between the support portion and the lower engagement piece.

According to this configuration, since the flexible portion is configured as a thin portion of the upper engagement piece, the flexible portion may have a simple configuration and may be easily formed compared to the case where the flexible portion is constituted by a member separate from the support portion.

According to the vehicle roof apparatus, the garnish may be separated from escaping from the movable panel.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A roof apparatus for a vehicle, comprising:
a movable panel configured to be movably attached to a roof of the vehicle;
a guide rail that guides the movable panel; and
a garnish connected to the movable panel and the guide rail,
wherein the garnish includes an attachment portion connected to an attachment panel of the movable panel at an upper side in a vehicle height direction, and an engagement portion slidably connected to the guide rail at a lower side in the vehicle height direction,
the attachment portion includes an upper extension piece extending outwards in a vehicle width direction, and a lower extension piece extending outwards in the vehicle width direction below the upper extension piece in the vehicle height direction and cooperating with the upper extension piece so that the attachment panel of the movable panel is interposed between the upper extension piece and the lower extension piece, and
the upper extension piece includes a first protrusion protruding downwards in the vehicle height direction so as to be engaged with an engagement portion of the attachment panel of the movable panel, and a second protrusion protruding upwards in the vehicle height direction, and is inserted into a gap between the movable panel and the attachment panel so as to be engaged with the attachment panel.

2. The roof apparatus according to claim 1,
wherein the second protrusion of the upper extension piece is made of a resin having elasticity.

3. The roof apparatus according to claim 1,
wherein the second protrusion of the upper extension piece extends obliquely upwards in a direction opposite to an extension direction of the upper extension piece.

4. The roof apparatus according to claim 1,
wherein the guide rail includes a first engagement wall, and a second engagement wall disposed below the first engagement wall in the vehicle height direction,
the engagement portion includes an upper engagement piece disposed above the first engagement wall of the guide rail in the vehicle height direction, and a lower engagement piece disposed below the first engagement wall in the vehicle height direction and cooperating with the upper engagement piece so that the first engagement wall is interposed between the upper engagement piece and the lower engagement piece,
the lower engagement piece includes a first contact portion upwardly protruding and being in contact with the first engagement wall, and a second contact portion downwardly protruding and being in contact with the second engagement wall, and
the upper engagement piece has a claw portion downwardly protruding to be engaged with an end of the first engagement wall, and a flexible portion allowing the upper engagement piece to be elastically bent.

5. The roof apparatus according to claim 4,
wherein the engagement portion includes the upper engagement piece, the lower engagement piece, and a support portion that supports the upper engagement piece and the lower engagement piece, and
the flexible portion of the upper engagement piece is configured as a constriction at a connection portion between the support portion and the upper engagement piece or a base portion at the support portion side, and is thinner than a thickness at a connection between the support portion and the lower engagement piece.
